(19) United States
(12) Patent Application Publication
(10) Pub. No.: US 2012/0062080 A1
(43) Pub. Date: Mar. 15, 2012

(54) DOOR SYSTEM FOR REFRIGERATED DISPLAY CABINETS

(76) Inventor: John Maslen, Queensland (AU)

(21) Appl. No.: 13/266,751

(22) PCT Filed: Apr. 30, 2010
(86) PCT No.: PCT/AU2010/000501

§ 371 Date: Nov. 16, 2011

(30) Foreign Application Priority Data
Apr. 30, 2009 (AU) 2009901898

(51) Int. Cl. F25D 23/02; E06B 7/16; E06B 3/36

(52) U.S. Cl. 312/116; 49/383

(57) ABSTRACT

A mullion-less door system for refrigerated display cabinets, chillers, cold rooms or freezers, incorporates offset seal members on the respective vertical stiles of adjacent doors, to form a labyrinth seal or gasket between the doors, while still allowing free operation of each, and without requiring indirect sealing via door mullions of the cabinet body or frame. Secondary seal members, incorporating magnetic gaskets, seal the top and bottom rails of the peripheral door frames, supporting transparent door panes, to the adjacent cabinet body or frame portions. Lighting assemblies may be incorporated in the vertical stiles to illuminate the contents of the cabinets; and the hinge assemblies may incorporate self-closing mechanisms for the doors.

### BACKGROUND OF THE INVENTION

1. Field of the Invention

This invention relates to a door system for refrigerated display cabinets.

The invention is particularly suitable for, but not limited to, a mullion-less door system for refrigerated display cabinets; but may also be used for other controlled- or ambient-environmental applications, including chillers and freezers, for the storage of foods or other articles.

Throughout the specification, the term “refrigerated display cabinets” shall be used to include (i) refrigerated cabinets, chillers and freezers of the types for the display of the refrigerated products typically sold in upright multi-level display refrigerators and freezer cases at supermarkets, grocery shops, fuel outlets, bottle shops, butcher shops, fruit shops, pet-food shops and the like, together with (ii) all other types of refrigerated cabinets and freezers for the (retail or wholesale) display and/or storage of foods or other articles.

2. Prior Art

Refrigerated products, including fresh and frozen foods, are typically displayed in open display cabinets; or behind glass doors, either mounted on refrigerated display cabinets, or providing consumer access to controlled-environment rooms or spaces.

Typically, these display cabinets can extend along the whole, or part of, the length of the aisles and/or walls in the supermarkets, shops or other retail or wholesale outlets.

The open display cabinets are not as energy efficient as the display cabinets using glass doors, as heat is drawn from the adjacent environment; but there is a resistance by many retailers to use the display cabinets having the glass doors, as these retailers believe the glass doors act as a “barrier” to their customers, resulting in reduced sales. Many of the retailers prefer the “open look” of the door-less open display cabinets; but are seeking energy efficient alternatives thereto.

While glass doors maybe retrofitted to existing open display cabinets, many retailers are concerned by the disruption to trading due to the complicated installation procedures.

The glass-door display cabinets typically have a mullion between each adjacent pair of doors; where the, or each, mullion typically houses at least one vertical light and protective cover(s) therefore, all of which protrude rearwardly into the refrigerated space; further impeding a clear view, to the consumers, of the products displayed within the display cabinets, when viewed looking along the length of the display.

The mullions are typically arranged to provide the surfaces of the cabinets against which the door seals (e.g. of a flexible gasket/seal type) provides sealing engagement between each door and its respective mullion.

The retailers must consider the balance between:

(i) the potential loss of sales by the fitting of glass doors to the open display cabinets; against:

(ii) the reduced size and operational requirements (including the reduced electricity (or other input energy) consumption) for the refrigerating/freezer units used to maintain the desired temperatures within the display cabinets fitted with doors, where the provision of the doors minimizes the ingress of heat from the surrounding environment into the display cabinets.

In addition, particularly with fresh fruit and vegetables, the air temperature and humidity within the display cabinets must be maintained within strict control limits to ensure maximum shelf life of the fresh foods.

### SUMMARY OF THE PRESENT INVENTION

It is an object of the present invention to provide a door system for refrigerated display cabinets (as hereinbefore defined) which is suitable for “retro-fitting” to existing open display cabinets and/or for installation in new refrigerated display cabinets.

It is a preferred object of the present invention to provide such a door system which seeks to minimize as many obstructions to the clear view, by consumers, of the products displayed within the refrigerated display cabinets, while still maintaining a high degree of thermal efficiency.

It is a further preferred object of the present invention to provide such a door system which may incorporate features such as self closing doors, effective minimization of cold air losses, an effective illumination of their display products, door-opening devices, ease of operation and/or ease of installation.

Other preferred objects of the present invention will become apparent from the following description:

In one aspect, the present invention resides in a mullion-less door system for a refrigerated display cabinet including:

at least one door, the or each door having at least one transparent pane surrounded by a peripheral door frame having a pair of vertical stiles;

respective upper and lower hinge members incorporated in, or mountable on, respective top and bottom rails of the peripheral frame, located at or adjacent one of the vertical stiles of the door, when in use; and

at least one seal member, is mounted on, or fixed to, one of the vertical stiles for sealing engagement with the other of the vertical stiles of an adjacent similar door and/or an adjacent body or frame portion of the refrigerated display cabinet.

Preferably, a second such seal member is mounted on, or fixed to, the other of the vertical stiles of the door for sealing engagement with the one vertical stile of a second adjacent similar door and/or another adjacent body or frame portion of the refrigerated display cabinet.

Preferably, the seal members on respective adjacent vertical stiles of the door and the adjacent similar doors are arranged to form of a flexible labyrinth seal or gasket between the doors.

Preferably, the seal members on the adjacent vertical stiles are offset, so as to not impede the operation of the doors, to allow the doors to open and close with minimal friction and effort, while minimising air leaks between the adjacent doors when both doors are closed.

Preferably, one or more secondary seal members extend at least partially around each peripheral frame, for sealing engagement of the door, when closed, to adjacent door and/or adjacent cabinet body or frame portions

Preferably, the secondary seal members along the top and bottom rails of the peripheral frame are, or incorporate, magnetic gaskets, which co-operate with the adjacent cabinet body or frame portions to improve the seal there-between.

Preferably, the, or each, transparent pane may be of single- or multi-layered glass; single or multi-layered plastic; combinations of glass and plastic; or of other suitable materials.

Preferably, the peripheral frame for the, or each, glass door is of metal such as aluminium or stainless steel); plastics; fiberglass or composite materials; or a combination of two or more of these materials.

Preferably, at least one of the vertical stiles of the peripheral frame incorporates one or more light assemblies, with LED(s) being preferred for their compactness & low heat emission. The, or each, light assembly may be connected to a door switch, which de-energizes one or more of the light assemblies, when the respective door is opened.

The upper and lower hinge members may incorporate sockets, bushes or other formations to receive respective hinge pins mounted in, or on, the adjacent cabinet body or frame portions; where the hinge pins may be mounted thereto by suitable brackets or sub-frames. Alternatively, the hinge pins may extend from the peripheral door frame, to be received in complementary sockets, bushes or other complementary formations, in or on, adjacent cabinet body or frame portions.

Preferably, each peripheral frame has at least one handle, attached to, or integral with, one of the vertical stile of the peripheral door frame.

Preferably, the, or each, seal member is formed of resilient, flexible material, such as natural- or synthetic rubber(s); plastics; or a combination of two or more of these materials; and the seal member(s) may be single- or multi-layered.

The, or each, door may be closed by a respective self-closing unit, which may include a self-loading torsion spring, and/or one or more cams installed over the (preferably lower) hinge pin(s).

In a second aspect, the present invention resides in a refrigerated display cabinet incorporating the mullion-less door system hereinbefore described.

### BRIEF DESCRIPTION OF THE DRAWINGS

To enable the invention to be fully understood, the preferred embodiments will now be described with reference to the accompanying drawings, in which:

FIG. 1 is front elevation view of a refrigerated display cabinet before the fitment of the doors in accordance with the present invention;

FIG. 2 is a similar view of a refrigerated display cabinet after the doors have been fitted;

FIG. 3 is a similar view of the refrigerated display cabinet fitted with one door of the present invention;

FIG. 4 is a top plan view illustrating one sealing arrangement between an adjacent pair of one embodiment of the doors;

FIGS. 5 & 6 are respective front and rear elevational views of the one embodiment of the doors;

FIG. 7 is a front elavational view of a second embodiment of the doors;

FIG. 8 is a perspective, part-sectional, view, of a top hinge assembly for the doors;

FIG. 9 is a perspective, part-sectional, view of a torsion-bar closer for use with the doors;

FIG. 10 is a top plan view of a second sealing arrangement between an adjacent pair of the second embodiment of the doors; and

FIG. 11 is a perspective view of a cam closer suitable for use with the doors.

### DETAILED DESCRIPTION OF THE PREFERRED EMBODIMENTS

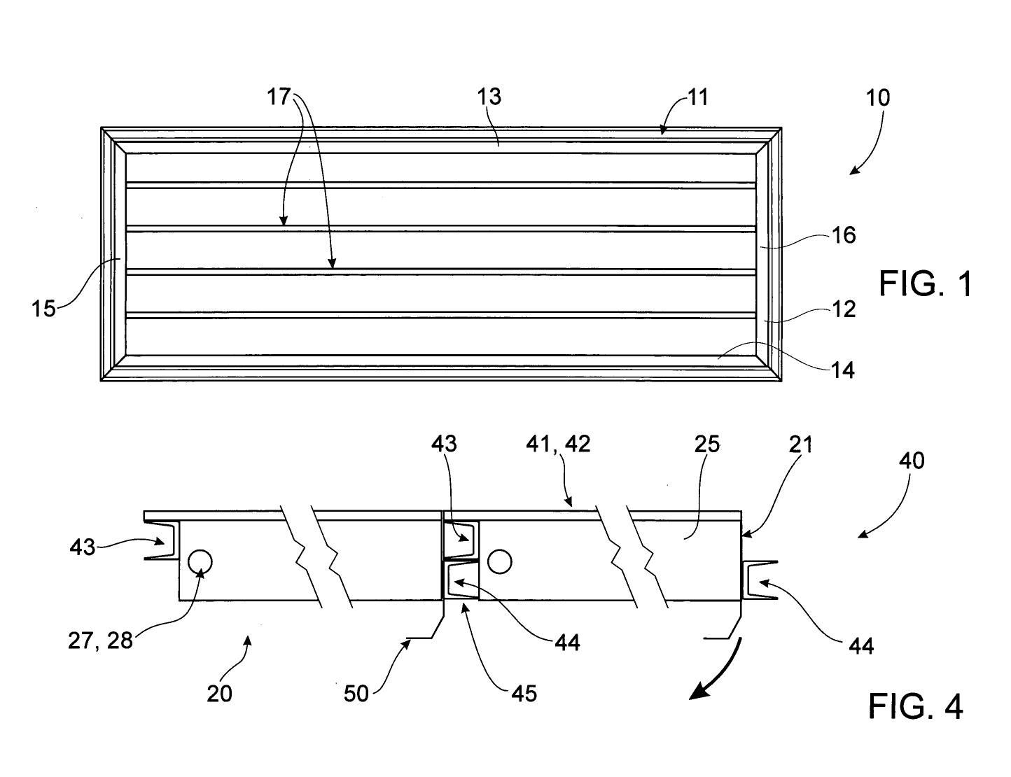

Referring to a first embodiment illustrated in FIG. 1 of the drawings, the refrigerated display cabinet 10 has a body 11, typically of sheet metal/expanded polystyrene foam (and/or other insulation foam)/sheet metal construction. One or both of the metal skins can be manufactured from stainless steel; or one or both of the sheet metal skins may be manufactured from sheet steel or aluminium, where the exposed face of the or each metal skin is provided with a suitable protective and/or ascetically-appealing coated finish.

At the front of the cabinet body 11, a mullion-less cabinet frame 12 is provided within the display cabinet 10, to enable the mounting of the door system, in accordance with the present invention, to be hereinafter descried.

The cabinet frame 12 has, in this embodiment, top and bottom (horizontal) frame members 13, 14, interconnected by a pair of vertical end members 15, 16, but not by door mullions.

A plurality of shelves 17, in this example being four (4) in number, are provided within the cabinet body 11, and may be vertically adjustable to enable the number of shelves 17 and/or the vertical spacings there-between to be varied.

NB: The skilled addressee will appreciate that different numbers of shelves 17, and the vertical spacing's there-between, may be provided along the length of the cabinet body 11 to provide the best display configuration for the different products (e.g. fresh fruit and vegetables, dairy products, meats and the like) being stored and displayed in the display cabinet 10.

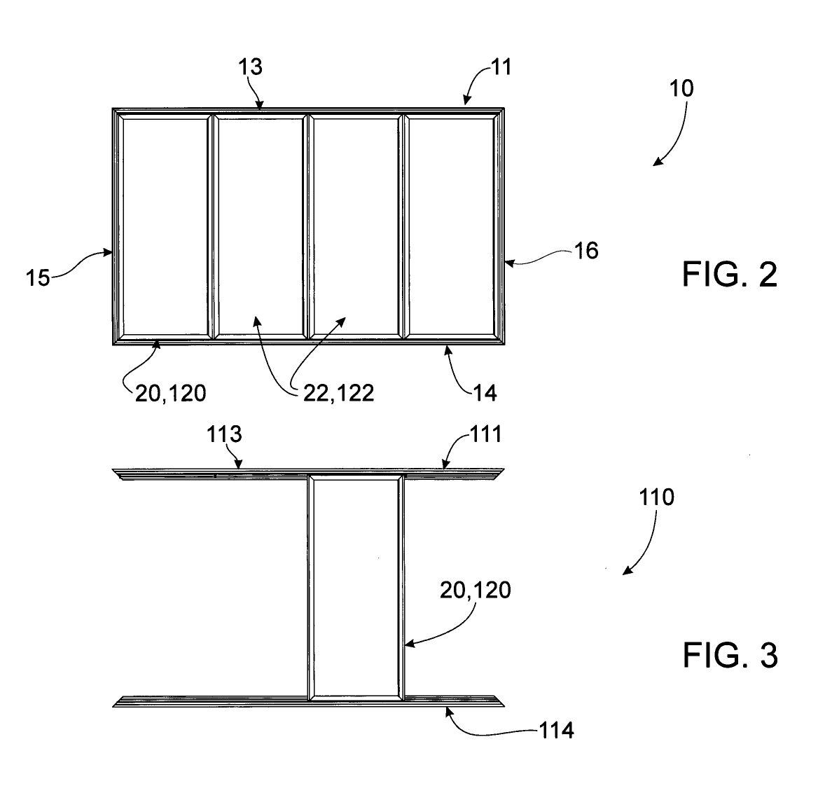

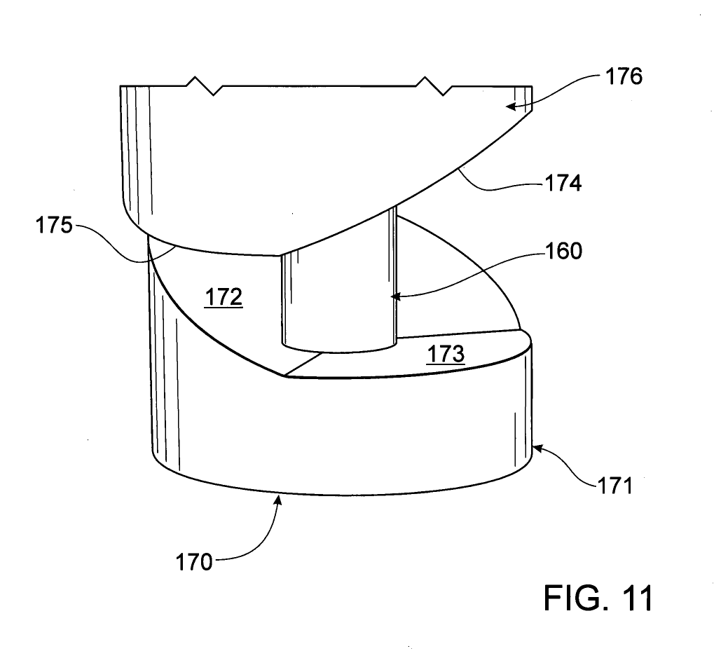

FIG. 2 illustrates a similar view of the refrigerated display cabinet 10 where, in this example, four (4) doors 20, 120 (in accordance with the present invention) have been fitted to the cabinet frame 12, and where the spaces between adjacent pairs of doors 20, 120 are sealed by sealing members 40, 140 to be hereinafter described in more detail with reference to FIGS. 4 and 10.

In the second embodiment of the refrigerated display cabinet 110, illustrated in FIG. 3, the cabinet frame 112 has continuous top and bottom frame members 113, 114 which are not connect by vertical end members or by door mullions. This embodiment may be preferred where the display cabinet 10A is to extend along the full length of a wall interconnecting a pair of spaced walls; or where the door system (in accordance with the present invention) is to be installed in a cold room (e.g. for alcoholic beverages), where the products on any of the shelves may be viewed and accessed by consumers either from inside or outside the cold room.

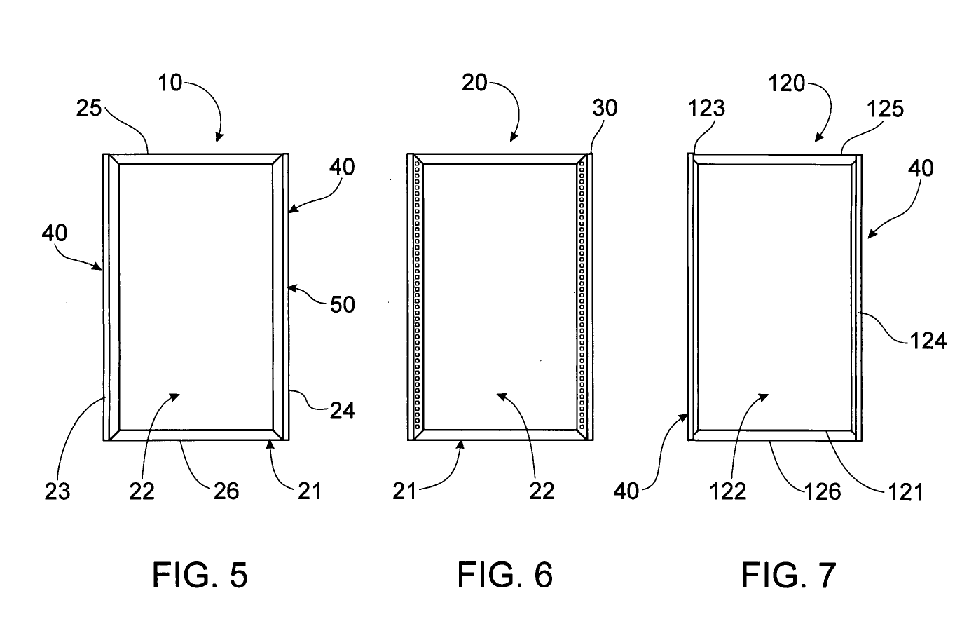

As illustrated in FIGS. 5 and 6 and FIG. 7, respective doors 20, 120 for the door system of the present invention maybe have “standard width” peripheral frames 21, as in FIGS. 5 and 6; or “slim-line” peripheral frames 121 with slim vertical stiles.

The doors 20, 120 have a transparent pane 22, 122 e.g. of single-or-multi-layered glass, single-or-multi- layered plastics materials; or a multi layered glass/plastics combination; where the multi- layers are preferably separated by an air-gap or vacuum-gap to minimise heat transfer to the interior of the display cabinets 10, 110.

The peripheral frame 21, 121 for each door 20, 120 has first and second vertical stiles 23, 123 and 24, 124 interconnected by top and bottom rails 25, 125 and 26, 126; and may be formed from metal, plastic, fibreglass or composite construction; or a combination of two or more of these materials (e.g. a pair of stainless steel or aluminum extrusions which are interlocked together).

A plurality of LED(s) 30, or other light fittings, may be recessed in the rear face of one or both of the vertical stiles 23, 24, 123, 124 to illuminate the interior of the display cabinet 10, 10A when the doors 20, 120 are closed.

Each door 20, 120 maybe be connected to a door switch (not shown) which will de-energize the LED's or lights 30 when the respective doors 20, 120 are open.

By locating the interior lighting for the display cabinets 10, 110 within the vertical stiles 23, 24, 123, 124, all of the generated light is directed into the display cabinets; and additional light housings, potentially restricting the view into the display cabinets, are not required

Referring to FIG. 4, magnetic gaskets 41, 42 are provided along the top and bottom rails 25, 26 of the peripheral frame 21 of each door 20 and are operable to engage the top and bottom frame members 13, 14 of the cabinet frame 12 when the doors 20 are closed. The magnetic characteristics of the magnetic gaskets 41, 42 can assist in fully closing the doors 20 and provide an increased effectiveness in the sealing between the doors 20 and the cabinet frame 12.

The first and second vertical stiles 23, 24 are provided with respective, substantially U-shaped, seal members 43, 44, typically extruded from natural-or-synthetic rubber and/ or plastics-material, where the seal member 43 on the first vertical stile 23 is rearwardly offset relative to the centre line of the peripheral frame 21, and so lies behind the complementary seal member 44 on the second vertical stile 24 of an adjacent door 20, to create a flexible labyrinth gasket 45, producing an effective sealing arrangement against air leakage between the adjacent pair of doors 20.

The skilled addressee will appreciate that the door seals 43, 44 of the adjacent doors 20 are designed to seal against each other and there are no vertical door mullions to providing indirect sealing between the adjacent doors 20.

By producing the seal members 43, 44 of a flexible material, such as natural-or-synthetic-rubber, plastics, and/or combinations thereof, the seal members 43, 44 will minimize air leaks between the adjacent doors 20, while allowing the respective doors 20 to open and close with minimal friction and effort.

To open the hingedly mounted doors 20, at least one handle 50 is provided on, or formed integrally with, the second vertical stile 24 of the peripheral frame 21 of each door 20, where the handle 50 may be of partial-or-full height of the door 20.

In the embodiments illustrated in the drawings, the doors 20, 120 are pivotally mounted to the top and bottom frame members 13, 13A, 14, 14A of the cabinet frame 12, 12A, about pivotal axes at or adjacent the first vertical stile 23, 123 of each peripheral frame 21, 121. (It will be appreciated by the skilled addressee that the pivotal axes may be moved towards the central vertical axis of each door 20, 120, so that when the door is opened the first vertical stile 23, 123 swings inwardly into the interior of the display cabinet 10, 10A thereby reducing the distance the doors 20, 120 swing outwardly in front of the display cabinet 10, 10A.

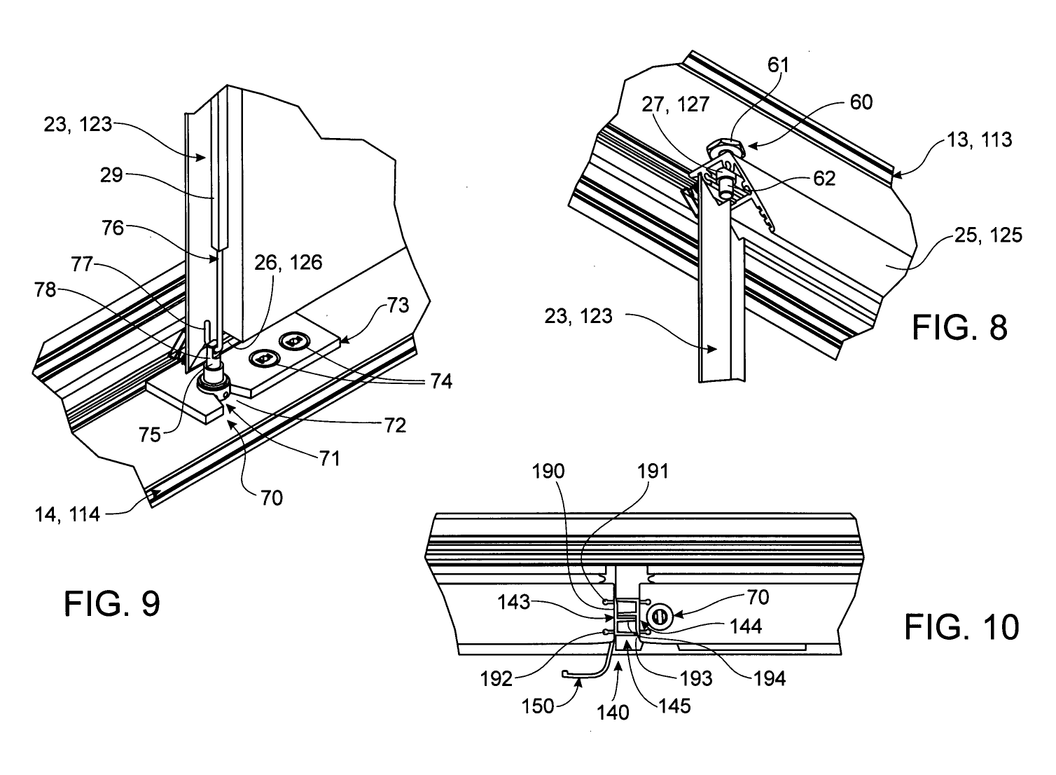

A respective socket or collar 27, 127, 28, 128 is provided in the top and bottom rails 25, 125, 26, 126 of the peripheral frames 21, 121 to receive the pivot pins of top and bottom hinge assemblies 60, 70, 170 to be hereinafter described with reference to FIGS. 8, 9 and 11, fitted to the top and bottom frame members 13, 113, 14, 114 of the cabinet frames 12, 112.

FIG. 8 illustrates a top hinge assembly 60 for the doors 20, 120.

The hinge assembly 60 has a base 61 fixed to the top frame member 13, 113 and has a vertical pivot pin 62 depending therefrom. The pivot pin 62 is rotatably received in the tubular collar or socket 27, 127 of the top rail 25, 125 of the door frame 21, 121, adjacent the first vertical stile 23, 123.

FIG. 9 illustrates a bottom hinge assembly 70 for the doors 20, 120, which incorporates a torsion-bar closer.

The bottom hinge assembly 70 has a body 71 located in a recess 72 in a base plate 73 fixed to the bottom frame member 14, 114 by screw-fasteners 74. A pivot pin 75 extends upwardly from the body 71 and is received in the socket or bore in the bottom rail 26, 126 of the peripheral door frame 21, 121.

A torsion bar 76 has a hook-member 77 releasably anchored in a diametrical bore 78 through the pivot pin 75, and its upper end is non-rotatably received in an insert 79 received in the first vertical stile 23, 123.

When the door 20, 120 is moved away from its closed position, the torsion bar 76 is “twisted” along its length, and urges the door 20, 120 to towards the closed position when released.

The torsion bar closer can be fitted within even the “thin” peripheral door frame 121 of door 120.

FIG. 10 illustrates a second embodiment of the sealing members forming the labyrinth sealing gasket or seal 145 between adjacent doors 20, 120.

The seal members 143, 144 can be manufactured, typically by extrusion, in a single configuration which is used in a mirror-image arrangement. Seal member 143 will only be described.

Seal member 143 has a body 190 with a pair of spaced formations 191, 192 respectively received in complementary grooves or recesses in the vertical stiles 23, 24, 123, 124. A first “lip” 193 extends from the body 190 adjacent a side edge thereof; while a second “lip” extends from the body 190 intermediate its length, and configured to overlap the second “lip” of the seal member 144 on the adjacent door 20, 120.

The distal ends of the “lips” 193, 194 of the seal member 143 are in sealing contact with the body 190 of the seal member 144; and vice versa.

As with the seal members 43, 44 illustrated in FIG. 4, the labyrinth seal 145 provides effective sealing between the doors 20, 120 when closed, without requiring a door mullion to ensure effective sealing between the doors.

As illustrated in FIG. 11, an alternative bottom hinge assembly 170, incorporating a cam-type closer, for self-closing of the doors 20, 120 may be provided at the bottom of each door 20, 120 where a lower cam member 171 is formed integrally with, or mounted in non-rotational relationship to, the lower pivot pin 161. The lower cam member 171 has an inclined-cam sector 172 and a substantially horizontal “closed position” sector 173. These sectors 172, 173 are respectively engagable by complimentary inclined-cam and “closed position” sectors 174, 175 on an upper cam member 176, co-axial with the adjacent socket or bush 28 on the bottom rail 26, 126 of the peripheral frame 21, 121 of the door 20, 120 and operable to rotate with the bottom rail 26, 126 and incorporates a bore with a clearance to co-axially receive the lower hinge pin 160.

When the door 20, 120 is closed, the respective inclined-cam and “closed position” sectors 172, 174 and 173, 175 of the lower and upper cam members 171, 176 are in respective “face-to-face” engagement. However, as the door 20, 120 is moved to the open position, the inclined-cam sector 174 of the upper cam member 176 “rides” up the inclined-cam sector 172 of the lower cam member 171 to thereby raise the door 20, 120 a small distance relative to the bottom frame member 14, 114 of the cabinet frame 12, 112.

When the door handle 50, 150 is released, gravity causes the inclined-cam sector 174 of the upper cam member 176 to move downwardly until the door 20, 120 is closed, and the respective pairs of sectors 172, 173, 174, 175 occupy their initial positions.

As particularly illustrated in FIGS. 2 and 3, the skilled addressee will appreciate that the present invention, by omitting the mullions and employing the door system of the present invention, a maximum viewing area is available, for the viewing of the goods within the display cabinet 10, 110 when the doors 20, 120 are closed, compared to existing refrigerated display cabinets which incorporate door mullions to enable sealing between adjacent pairs of doors.

In addition, by recessing the lighting assemblies 30 into the rear faces of the vertical stiles 23, 24, 123, 124 of the peripheral frames 21, 121; and more particularly, if light assemblies 30 such as LED's are selected which do not require clear cover panels; then the effective obstruction to the viewing of the contents of the display cabinets 10, 110 by the doors 20, 120 is further reduced.

In addition, the arrangement of the sealing members 40, 140 on the doors 201 120, as illustrated in FIGS. 4 and 10, provides a high level of sealing efficiency between adjacent pairs of doors 20, 120 when closed, whilst still allowing the doors 20, 120 to be easily opened and closed.

The skilled addressee will appreciate that the present invention provides a highly effective door system for refrigerated display cabinets 10, 110, where the disadvantages of existing-type door mullions are overcome; and where the invention can be applied to both existing refrigerated display cabinets, by way of “retro-fitted” installations; or as “original equipment manufacture” (OEM) in new refrigerated display cabinets.

Various changes and modifications may be made to the embodiments described and illustrated without departing from the present invention.

1. A mullion-less door system for a refrigerated display cabinet including:
at least one door, the or each door having at least one transparent pane surrounded by a peripheral frame having a pair of vertical stiles;
respective upper and lower hinge members incorporated in, or mountable to, respective top and bottom rails of the peripheral frame, located at or adjacent one of the vertical stiles of the door, when in use; and
at least one seal member, mounted on, or fixed to, one of the vertical stiles for sealing engagement with the other of the vertical stiles of an adjacent similar door and/or with an adjacent body or frame portion of the refrigerated display cabinet.

2. The system of claim 1, wherein:
at least one seal member is mounted on, or fixed to, the other of the vertical stiles of the door for sealing engagement with the one vertical stile of a second adjacent similar door and/or another adjacent body or frame portion of the refrigerated display cabinet.

3. The system of claim 2, wherein:
the seal members on respective adjacent vertical stiles of the door and the adjacent similar doors are arranged to form of a flexible labyrinth seal or gasket between the doors.

4. The system of claim 3, wherein:
the seal members on the adjacent vertical stiles are offset, so as to not impede the operation of the doors, to allow the doors to open and close with minimal friction and effort, while minimising air leaks between the adjacent doors when both doors are closed.

5. The system of claim 1, wherein:
one or more secondary seal members extend at least partially around each peripheral frame, for sealing engagement of the door, when closed, to adjacent door and/or adjacent cabinet body or frame portions

6. The system of claim 5, wherein: the secondary seal members along the top and bottom rails of the peripheral frame are, or incorporate, magnetic gaskets, which co-operate with the adjacent cabinet body or frame portions to improve the seal there-between.

7. The system of claim 1, wherein:
the, or each, transparent pane is of single- or multi-layered glass; single or multi-layered plastics; combinations of glass and plastic; or other at least semi-transparent materials.

8. The system of claim 1, wherein:
the peripheral frame for the, or each, door is of metal, such as aluminium or stainless steel; plastics; fibreglass, or composite material construction; or a combination of two or more of these materials.

9. The system of claim 1, wherein:
at least one of the vertical stiles of the peripheral frame incorporates one or more light assemblies; and
the one or more light assemblies are operably connected to a door switch, which de-energizes the one or more of the light assemblies when the respective door is opened.

10. The system of claim 1, wherein:
the upper and lower hinge members incorporate sockets, bushes or other formations to receive respective hinge pins of top and bottom hinge assemblies mounted in, or on, the adjacent cabinet body or frame portions; where the hinge pins are mounted thereto by suitable brackets or sub-frames; or
respective hinge pins of the upper and lower hinge members extend from the peripheral frame of a door and are received in complementary sockets, bushes or other complementary formations, in or on, the adjacent cabinet body or frame portions.

11. The system of claim 1, wherein:
the, or each, door is closed by a respective self-closing unit, which incorporates a self-loading torsion bar or spring, and/or one or more cams, incorporated in, or co-operating with the upper or lower hinge members.

12. The system of claim 1, wherein:
the, or each, seal member is formed of resilient, flexible material, such as natural- or synthetic rubbers; plastics; or a combination of two or more of these materials; and the seal members may be single- or multi-layered.

13. A refrigerated display cabinet fitted with the system as claimed in claim 1.
